(19) United States
(12) Patent Application Publication
(10) Pub. No.: US 2009/0146345 A1
(43) Pub. Date: Jun. 11, 2009

(54) Preform design for injections stretch blow molding

(75) Inventors: Luyi Sun, Houston, TX (US); Dang Le, Houston, TX (US); David Smith, LaPorte, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 11/999,913

(22) Filed: Dec. 5, 2007

(51) Int. Cl. B29C 49/06

(52) U.S. Cl. 264/535; 428/35.7

(57) ABSTRACT

Preforms for use in injection stretch blow molding processes and such processes are described herein. The preforms generally include a neck having an internal neck diameter and an external neck diameter and a body having an internal body diameter and an external body diameter, the internal body diameter and the external body diameter forming a sidewall, wherein the internal body diameter is at least 80% of the internal neck diameter. The preforms further include an end-cap positioned on the body at a transition point and having an end-cap depth and a transition point radius, wherein the end-cap depth is greater than the transition point radius.

### FIELD

Embodiments of the present invention generally relate to injection stretch blow molding. In particular, embodiments of the invention relate to preforms for injection stretch blow molding of propylene based polymers.

### BACKGROUND

Historically, polyester terephthalate (PET) has been utilized for the formation of injection stretch blow molding preforms, which are used to form injection stretch blow molded (ISBM) articles, such as liquid containers (including bottles and wide mouth jars), for example. Attempts have been made to utilize lower cost materials, such as polypropylene, for the preforms. However, properties of propylene based polymers (including coefficient of thermal transfer and melt strength) have generally resulted in preforms exhibiting lower processability than preforms formed by PET, primarily during the reheat, stretch and blow steps.

Accordingly, the design of such preforms is an important factor in whether propylene based polymers can cost-effectively be utilized to form ISBM articles. Therefore, a need exists for the development of an injection stretch blow molding process capable of utilizing propylene based polymers at a low overall production cost (which includes raw material cost and manufacturing speed or efficiency).

### SUMMARY

Embodiments of the present invention include preforms for use in injection stretch blow molding processes. The preforms generally include a neck having an internal neck diameter and an external neck diameter and a body having an internal body diameter and an external body diameter, the internal body diameter and the external body diameter forming a sidewall, wherein the internal body diameter is at least 80% of the internal neck diameter. The preforms further include an end-cap positioned on the body at a transition point and having an end-cap depth and a transition point radius, wherein the end-cap depth is greater than the transition point radius.

Embodiments further include methods of forming injection stretch blow molded articles. The methods generally include providing a propylene based polymer, forming the preform from the propylene based polymer, heating the preform and injection stretch blow molding the preform into an article.

### BRIEF DESCRIPTION OF DRAWINGS

FIGS. 1A and 1B illustrate side and cross-sectional views of prior art preform designs.

FIGS. 2A and 2B illustrate side and cross-sectional views of one embodiment of an inventive preform design.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents at the time of filing. Further, unless otherwise specified, all compounds described herein may be substituted or unsubstituted and the listing of compounds includes derivatives thereof.

Various ranges are further recited below. It should be recognized that unless stated otherwise, it is intended that the endpoints are to be interchangeable. Further, any point within that range is contemplated as being disclosed herein.

As used herein, the term “room temperature” means that a temperature difference of a few degrees does not matter to the phenomenon under investigation. In some environments, room temperature may include a temperature of from about 20° C. to about 28° C. (68° F. to 82° F.), while in other environments, room temperature may include a temperature of from about 50° F. to about 90° F., for example. However, room temperature measurements generally do not include close monitoring of the temperature of the process and therefore such a recitation does not intend to bind the embodiments described herein to any predetermined temperature range.

### Catalyst Systems

Catalyst systems useful for polymerizing olefin monomers include any catalyst system known to one skilled in the art. For example, the catalyst system may include metallocene catalyst systems, single site catalyst systems, Ziegler-Natta catalyst systems or combinations thereof, for example. As is known in the art, the catalysts may be activated for subsequent polymerization and may or may not be associated with a support material. A brief discussion of such catalyst systems is included below, but is in no way intended to limit the scope of the invention to such catalysts.

For example, Ziegler-Natta catalyst systems are generally formed from the combination of a metal component (e.g., a catalyst) with one or more additional components, such as a catalyst support, a cocatalyst and/or one or more electron donors, for example.

Metallocene catalysts may be characterized generally as coordination compounds incorporating one or more cyclopentadienyl (Cp) groups (which may be substituted or unsubstituted, each substitution being the same or different) coordinated with a transition metal through π bonding. The substituent groups on Cp may be linear, branched or cyclic hydrocarbyl radicals, for example. The cyclic hydrocarbyl radicals may further form other contiguous ring structures, including indenyl, azulenyl and fluorenyl groups, for example. These contiguous ring structures may also be substituted or unsubstituted by hydrocarbyl radicals, such as C₁ to C₂₀ hydrocarbyl radicals, for example.

### Polymerization Processes

As indicated elsewhere herein, catalyst systems are used to form polyolefin compositions. Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form polymers. The olefin monomers may include C₂ to C₃₀ olefin monomers, or C₂ to C₁₂ olefin monomers (e.g, ethylene, propylene, butene, pentene, methylpentene, hexene, octene and decene), for example. The monomers may include olefinic unsaturated monomers, C₄ to C₁₈ diolefins, conjugated or nonconjugated dienes, polyenes, vinyl monomers and cyclic olefins, for example. Non-limiting examples of other monomers may include norbomene, nobornadiene, isobutylene, isoprene, vinylbenzocyclobutane, sytrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process with the exception that the liquid medium is also the reactant (e.g., monomer) in a bulk phase process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any method known to one skilled in the art, such as via a double-jacketed pipe or heat exchanger, for example.

Alternatively, other types of polymerization processes may be used, such as stirred reactors in series, parallel or combinations thereof, for example. Upon removal from the reactor, the polymer may be passed to a polymer recovery system for further processing, such as addition of additives and/or extrusion, for example. It is to be noted that while additives, such as nucleators are known to one skilled in the art and are contemplated for use in the embodiments described herein, embodiments of the invention are capable of obtaining benefits, such as uniform polymer distribution and clarity without the used thereof.

### Polymer Product

The polymers (and blends thereof) formed via the processes described herein may include, but are not limited to, polypropylene and polypropylene copolymers, for example.

In one or more embodiments, the polypropylene and polypropylene copolymers include propylene based polymers. Unless otherwise specified, the term “propylene based” refers to polymers whose primary component is propylene (e.g., at least about 50 wt. %, or at least about 75 wt. %, or at about least 80 wt. % or at least about 89 wt. %).

In one or more embodiments, the polypropylene and polypropylene copolymers include propylene based random copolymers (used interchangeably herein with the term “random copolymer”). Unless otherwise specified, the term “propylene based random copolymer” refers to those copolymers composed primarily of propylene and an amount of other comonomers, wherein the comonomers make up at least about 0.5 wt. %, or at least about 0.8 wt. % or at least about 2 wt. % by weight of polymer, for example. The comonomers may be selected from C₂ to C₁₀ alkenes. For example, the comonomers may be selected from ethylene, propylene, 1-butene, 1-pentene, 1-hexene, 1-heptene, 1-octene, 1-nonene, 1-decene, 4-methyl-1-pentene and combinations thereof. In one specific embodiment, the comonomer includes ethylene.

In one or more embodiments, the polypropylene includes propylene homopolymers. Unless otherwise specified, the term “propylene homopolymers” refers to those polymers composed primarily of propylene and limited amounts of other comonomers, such as ethylene, wherein the comonomer make up less than about 2 wt. % (e.g., mini random copolymers), or less than about 0.5 wt. % or less than about 0.1 wt. % by weight of polymer.

It is to be noted that although the ranges of random copolymers and homopolymers may overlap, whether the compound is a random copolymer or a homopolymer will be clear from the context of its use.

Unless otherwise designated herein, all testing methods are the current methods at the time of filing.

In one embodiment, the propylene polymers may have a melt index (MI) of from about 0.01 dg/min to about 1000 dg/min., or from about 0.01 dg/min. to about 100 dg/min., or from about 0.02 dg/min. to about 50 dg/min., or from about 0.03 dg/min. to about 10 dg/min. or from about 3.0 dg/min. to about 5.0 dg/min., for example.

### Product Application

The polymers and blends thereof are useful in applications known to one skilled in the art, such as forming operations (e.g., film, sheet, pipe and fiber extrusion and co-extrusion as well as blow molding, injection molding and rotary molding). Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, monofilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, sheet, thermoformed sheet, geomembranes and pond liners, for example. Molded articles include single and multi-layered constructions in the form of bottles, tanks, large hollow articles, rigid food containers and toys, for example.

In one embodiment, the polymers are used in injection stretch blow molding (ISBM). ISBM may be used to produce containers, such as bottles and jars. Such processes are generally known to one skilled in the art. For example, ISBM processes may include injection molding the polymer into a preform, reheating the preform and subsequently stretching and blowing the preform into an article.

Preforms are generally condensed shapes, which may include relatively thick-walled test tube like articles having a threaded neck to facilitate appropriate closure. The preforms can be blown into a desired ISBM article shape by heating, stretching, and blowing the preform with a sudden blast of air, for example. The air blast expands the preform into the shape of the mold.

The shape and thickness of the preform determines not only the processability and production rate for the ISBM process, but also the properties of the ISBM article, including mechanical, physical, and optical properties. As used herein, the term “processability”, which is used interchangeable with the term “processing window”, refers to the sensitivity of a polymer to changes in the heating temperature from a predetermined set point. For example, a narrower processing window results in more sensitivity to temperature change and vice versa. When a polymer is “sensitive” to the temperature change, a slight non-uniform heating will have a significant effect on the resin distribution. This can lead to polymer unevenly distributing in the mold, resulting in an article weakness that may lead to failure. As used here, “failure” is measured by visual inspection and usually results from concentrating (either stretching too much or too little) in any region on an article or blow-out. The article defects may further be measured via mechanical testing.

Historically propylene based polymer preform designs have been adopted from polyester terephalate (PET) preform designs, which are generally characterized by a thick preform side-wall and a body that is narrower than the neck of the preform.

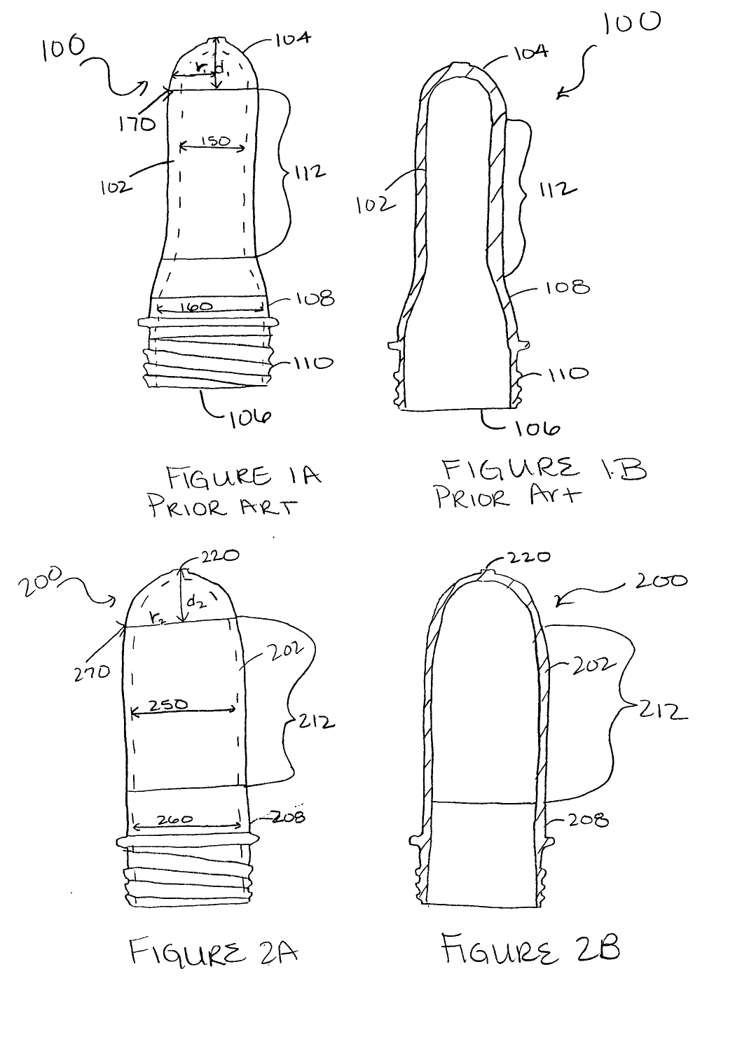

FIGS. 1A and 1B illustrate a preform design 100 adapted from conventional PET preforms, which has been utilized for the production of polypropylene preforms. Unfortunately, conventional preforms 100 have relatively thick side-walls 102 (which run throughout the body 112, end-cap 104 and neck 108), which often result in article failure during later processing (e.g., stretching and blowing). While it is known to one skilled in the art that the thickness of the side-wall may vary with the weight of the preform, preform 100 generally has a side-wall thickness of at least 3.0 mm and, in the case of a 23 g. preform, has a side-wall thickness of at least 3.5 mm., for example. The thick side-wall not only hinders heat transfer, but also negatively impacts polymer distribution on the side wall during blowing.

However, embodiments of the invention generally reduce the thickness of the side-wall 202, resulting in improved heat transfer (and ultimately energy savings therefrom) and polymer distribution upon stretching and blowing. See, FIGS. 2A and 2B illustrating an embodiment of the invention. For example, embodiments of the invention may include a side-wall thickness that is less than 3.5 mm, or less than 3.2 mm, or less than 3.0 mm or less than 2.8 mm, for example. The side-wall thickness may be reduced via design changes discussed in further detail below. Again, it is noted that the thickness of the side-wall 202 may vary with the weight of the preform 200. Therefore, the side-wall thicknesses of embodiments of the invention, unless specifically indicated otherwise, refer to the side-wall thickness of a preform weight of about 23 g.

Typically, preform 100 includes an internal body diameter 150 that is significantly narrower (e.g., smaller) than an internal diameter 160 of the neck 108. For example, some of the preforms 100 have an internal body diameter 150 that is about 40% narrower than the internal diameter 160. However, at least one embodiment of the invention generally includes an internal body diameter 250 that is approximately the same as the internal diameter 260 of the neck 208. Another embodiment of the invention includes an internal body diameter that is at least about 70%, or at least about 75%, or at least about 80% or at least about 85% of the internal body diameter of the neck. At least one embodiment of the invention generally includes an external body diameter that is approximately the same as the external diameter 208 of the neck.

In addition to relatively thick walls, conventional preforms 100 have further included a relatively quick transition from the body 112 of the preform to the end-cap 104 (e.g., bottom). Such a transition may be demonstrated by the ratio of the depth of the end-cap (d₁) to the radius of the end-cap (r₁, the radius of the circle of latitude) at the transition position. Many conventional preform designs 100 have included a depth d₁ that is less than the radius r₁ at the point of transition 170. However, a quick transition (e.g., a low ratio of d₁:r₁) often results in poor polymer distribution therethrough during blowing especially in bottle bottom area, potentially resulting in article failure. This failure is further demonstrated in applications requiring a hot fill (e.g., filling the article with a hot fluid rather than a room temperature fluid).

However, one or more embodiments of the invention include a preform 200 having an end-cap depth d₂ that is greater than the radius r₂ of the end-cap at the point of transition 270 (the radius of the circle of latitude at the point of transition 270). The large ratio of d₂:r₂ generates a slow transitional end-cap. Further more, the gradual transition can be demonstrated by the fact that the minimum radius of any point on the end-cap (R, the radius of dome at any point) is sufficiently large as to provide the gradual reduction (e.g., the radius R is greater than about ⅓ of the end-cap depth d₂). Such a transition has unexpectedly resulted in more uniform distribution of polymer in the end-cap and therefore less article failure.

Embodiments of the invention may further include an end-cap design wherein the end-cap thickness near the gate 220 (the point of polymer injection) is less than the end-cap thickness at the transition point 270. However, it is to be noted that the end-cap thickness at the gate 220 is still sufficient to avoid puncture during stretching, which will depend upon the specific polymer used. For example, higher melt flow polypropylene is easier to puncture than lower melt flow polypropylene. Since the area close to the injection gate 220 usually undergoes less orientation than the body 212 of the preform during processing, the new design balances the reduction in orientation by reducing the thickness of that area 220, resulting in reduced orientation (stretch or blow) stress in this area, thereby achieving sufficient orientation and clarity.

Unexpectedly, embodiments of the invention result in ISBM processes having at least about 90%, or at least about 95%, or at least about 97% or at least about 98% efficiency (i.e., percentage of acceptable articles produced per run). The term “acceptable articles” refers to articles that are not susceptible to failure, as defined further above.

### EXAMPLES

Injection stretch blow molded articles were prepared from a variety of preform designs.

As used below, “Preform A” was a 21 g. preform having the prior art design (including a 3.05 mm side-wall thickness). “Preform B” was a 23 g. preform having the prior art design (including a 3.58 mm side-wall thickness) and “Preform C” was a 23 g preform having the inventive design (including a 2.80 mm side-wall thickness). All preforms were injection molded from 7525MZ polypropylene, commercially available from TOTAL Petrochemicals, USA, Inc. The preforms were conditioned at room temperature for at least 24 hours and then each preform was stretch-blow molded into bottles at an injection speed of 5 mm/s, as shown in Table 1 below.

TABLE 1

| | Preform A | | Preform B | | | |
|---|---|---|---|---|---|---|
| | (Comparative) | | (Comparative) | | Preform C | |
| Prod. Rate | 1000 | 1500 | 1000 | 1500 | 1000 | 1500 |
| [b/(h · cavity)] | | | | | | |
| Acceptability (%) | 65 | 40 | <10 | NR | 100 | 100 |

Unexpectedly, it was observed that preform C produced acceptable bottles at a rate of 100% even at a production rate of 1500 b/(h·cavity), while the comparative preforms produced acceptable bottles at significantly lower rates. Neither gloss nor haze was detrimentally affected as a result of the new preform design. In fact, high top load and bumper compression strength have been achieved owing to the better material distribution and more uniform orientation. Higher clarity in the bottom of the bottle was also observed.

It was further observed that preform C was able to be processed in a wider processing window than the comparative preforms. In addition, lower heating powers were observed, thereby resulting in energy savings.

While the foregoing is directed to embodiments of the present invention, other and further embodiments of the invention may be devised without departing from the basic scope thereof and the scope thereof is determined by the claims that follow.

What is claimed is:

1. A preform for use in injection stretch blow molding processes comprising:
a neck comprising an internal neck diameter and an external neck diameter;
a body comprising an internal body diameter and an external body diameter, the internal body diameter and the external body diameter forming a sidewall, wherein the internal body diameter is at least 80% of the internal neck diameter; and
an end-cap positioned on the body at a transition point and comprising an end-cap depth and a transition point radius, wherein the end-cap depth is greater than the transition point radius.

2. The preform of claim 1, wherein the internal body diameter is approximately the same as the internal neck diameter.

3. The preform of claim 1, wherein the end-cap further comprises a gradual reduction in a ratio of radius to depth and a starting ratio is not greater than about 1:1.2.

4. The preform of claim 1, wherein the end-cap comprises a first thickness at the transition point and a second thickness at the gate, wherein the second thickness is less than the first thickness and is gradually reduced from the first thickness to the second thickness.

5. The preform of claim 1, wherein the preform comprises polypropylene.

6. The preform of claim 5, wherein the preform further comprises polyethylene.

7. A method of forming an injection stretch blow molded article comprising;
providing a propylene based polymer;
forming a preform from the propylene based polymer, wherein the preform comprises:
a neck comprising an internal neck diameter and an external neck diameter;
a body comprising an internal body diameter and an external body diameter, the internal body diameter and the external body diameter forming a sidewall, wherein the internal body diameter is at least 80% of the internal neck diameter; and
an end-cap positioned on the body at a transition point and comprising an end-cap depth and a transition point radius, wherein the end-cap depth is greater than the transition point radius;
heating the preform; and
injection stretch blow molding the preform into an article.

8. The method of claim 7, wherein the method has an efficiency of at least 95%.

9. An injection stretch blow-molded (ISBM) article formed by the process of claim 7.

10. The method of claim 7, wherein the external body diameter is approximately the same as the external neck diameter.

11. The method of claim 7, wherein the end-cap further comprises a gradual reduction in a ratio of radius to depth and a starting ratio is not greater than about 1:1.2.

12. The method of claim 7, wherein the end-cap comprises a first thickness at the transition point and a second thickness at the gate, wherein the second thickness is less than the first thickness and is gradually reduced from the first thickness to the second thickness.

13. The method of claim 7, wherein the preform comprises polypropylene.

14. The method of claim 13, wherein the preform further comprises polyethylene.
